(19) United States
(12) Patent Application Publication
(10) Pub. No.: US 2011/0226290 A1
(43) Pub. Date: Sep. 22, 2011

(54) APPARATUS FOR WET PROCESSING SUBSTRATE

(75) Inventors: YONG-JIAN XUE, Huai An (CN); JUN CHEN, Huai An (CN)

(73) Assignees: Hong Heng Sheng Electronical Technology (HuaiAn) Co., Ltd., Huai An City (CN); FOXCONN ADVANCED TECHNOLOGY INC., Tayuan (TW)

(21) Appl. No.: 12/834,007

(22) Filed: Jul. 11, 2010

(30) Foreign Application Priority Data
Mar. 22, 2010 (CN) 201010128761.7

(51) Int. Cl. B08B 3/00

(52) U.S. Cl. 134/151; 134/109

(57) ABSTRACT

An exemplary apparatus for wet processing a substrate includes a wet processing system and a water supplying system. The wet processing system includes a preliminary rinsing device, a final rinsing device, and a conveyor. The preliminary rinsing device includes a first tank and a first spraying system above the first tank. The final rinsing device includes a second tank and a second spraying system above the second tank. The conveyor is configured for conveying a substrate from the preliminary rinsing device to the final rinsing device. The water supplying system includes a supply pipe configured for supplying water to the second spraying system, a connecting system communicating the second tank and the first spraying system, and a drain pipe communicating with the first tank.

### BACKGROUND

1. Technical Field

The present disclosure generally relates to an apparatus and particularly, to an apparatus for wet processing a substrate of a printed circuit board (PCB).

2. Description of Related Art

During the manufacturing of PCBs, it is normal practice to feed the PCBs through a series of processing machines on a conveyor system. The process includes pre-cleaning, scrubbing, neutralizing, developing, etching, stripping, and so on. Pre-cleaning, neutralizing, developing, and etching, are known as wet processing steps. However, after each of these wet processing steps, at least one step of water rinsing is needed to clean the PCBs. In each step of water rinsing, a lot of water is supplied to a rinsing machine to rinse the PCBs and then drained out as wastewater. That is, a significant amount of water is wasted in the procedure of manufacturing PCBs.

What is needed, therefore, is an apparatus for wet processing a substrate which conserves the amount of water used in this process.

### BRIEF DESCRIPTION OF THE DRAWINGS

Many aspects of the present apparatus may be better understood with reference to the following drawings. The components in the drawings are not necessarily drawn to scale, the emphasis instead being placed upon clearly illustrating the principles of the present apparatus. Moreover, in the drawings, all the views are schematic, and like reference numerals designate corresponding parts throughout the several views.

FIG. 1 is an apparatus for wet processing a substrate, in accordance with a first embodiment.

FIG. 2 is an apparatus for wet processing a substrate, in accordance with second embodiment.

FIG. 3 is an apparatus for wet processing a substrate, in accordance with a third embodiment.

FIG. 4 is an apparatus for wet processing a substrate, in accordance with fourth embodiment.

FIG. 5 is an apparatus for wet processing a substrate, in accordance with a fifth embodiment.

### DETAILED DESCRIPTION

Reference will now be made to the drawings to describe, in detail, embodiments of the wet processing apparatus.

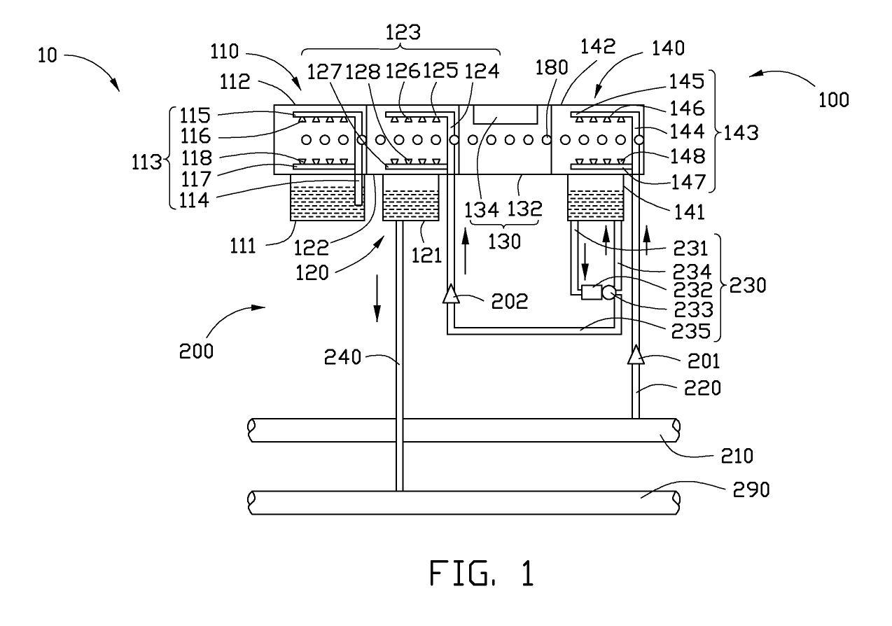

Referring to FIG. 1, an apparatus 10 for wet processing a substrate, in accordance with a first embodiment, is shown. The apparatus 10 comprises a wet processing system 100 and a water supplying system 200.

The wet processing system 100 comprises an acid cleaning device 110, a preliminary rinsing device 120, a scrubbing device 130, a final rinsing device 140, and a conveyor 180 extending through the devices 110 through 140. The conveyor 180 may be a number of rollers, which are capable of conveying substrates thereon by rotating. The devices 110 through 140 are arranged close together along a line in sequence of processing steps of a substrate. In the illustrated embodiment, the processing steps are acid cleaning, preliminary water rinsing, scrubbing, and final water rinsing, and the conveyor 180 is capable of conveying substrates from the step of acid cleaning to the step of final water rinsing.

The acid cleaning device 110 is configured for cleaning a substrate placed on the conveyor 180. The acid cleaning device 110 includes a first tank 111, a first housing 112 above the first tank 111, and a first spraying system 113. The first tank 111 is configured for receiving/collecting a wet processing liquid, which is capable of acid cleaning a substrate, such as acetic acid. The first housing 112 is communicated with the first tank 111, and is configured for accommodating portion of the conveyor 180 and the first spraying system 113. The first spraying system 113 is used to spray the wet processing liquid in the first tank 111 to the substrate on the conveyor 180. In the illustrated embodiment as shown in FIG. 1, the first spraying system 113 includes a first conveying pipe 114, a first upper pipe 115 above the conveyor 180, a number of first upper nozzles 116 mounted on the first upper pipe 115, a first lower pipe 117 below the conveyor 180, and a number of first lower nozzles 118 mounted on the first lower pipe 117. One end of the first conveying pipe 114 is immersed in the wet processing liquid in the first tank 111, the other end of the conveying pipe 114 is connected and communicates with the first upper pipe 115. The first lower pipe 117 also communicates with the first upper pipe 115, and is substantially connected at a central portion of the first conveying pipe 114. Therefore, the wet processing liquid in the first tank 111 may be conveyed to the first upper and lower pipes 115, 117, and the first upper and lower nozzles 116, 118 may spray the wet processing liquid to two opposite sides of the conveyor 180. In other words, two opposite sides of the substrate, which is placed on the conveyor 180, can be simultaneously sprayed and cleaned by the first spraying system 113.

The preliminary rinsing device 120 includes a second tank 121 for receiving water therein, a second housing 122 above the second tank 121, and a second spraying system 123 configured for rinsing a substrate placed on the conveyor 180. The second spraying system 123 and portion of the conveyor 180 are accommodated in the second housing 122. The second spraying system 123 has a structure similar to the first spraying system 113 of the first acid cleaning device 110, and includes a second conveying pipe 124, a second upper pipe 125 above the conveyor 180, a number of second upper nozzles 126 mounted on the second upper pipe 125, a second lower pipe 127 below the conveyor 180, and a number of second lower nozzles 128 mounted on the second lower pipe 127. The second tank 121 and the second conveying pipe 124 each communicate with the water supplying system 200.

The scrubbing device 130 includes a third housing 132 and a scrubbing element 134 accommodated in the third housing 132. The scrubbing element 134 is above and adjacent to the conveyor 180, and is configured for contacting and scrubbing a substrate placed on the conveyor 180.

The final rinsing device 140 includes a fourth tank 141 configured for receiving water therein, a fourth housing 142 above the fourth tank 141, and a fourth spraying system 143 configured for rinsing a substrate placed on the conveyor 180. The fourth spraying system 143 and portion of the conveyor 180 are accommodated in the fourth housing 142. The fourth spraying system 143 has a structure similar to the second spraying system 123 of the first preliminary rinsing device 120, and includes a third conveying pipe 144, a third upper pipe 145 above the conveyor 180, a number of third upper nozzles 146 mounted on the third upper pipe 145, a third lower pipe 147 below the conveyor 180, and a number of third lower nozzles 148 mounted on the third lower pipe 147. The third conveying pipe 144 and the fourth tank 141 each communicate with the water supplying system 200.

The water supplying system 200 is arranged below the wet processing system 100, and is configured for supplying purified water to the final rinsing device 140 and drainage of the wastewater from the preliminary rinsing device 120. The water supplying system 200 includes a water supplying conduit 210, a supply pipe 220, a connecting system 230, a drain pipe 240, and a drainage conduit 290.

The water supplying conduit 210 is substantially parallel with the line along which the devices 110 through 140 are arranged. The water supplying conduit 210 is configured for supplying purified water to the supply pipe 220. Purified water is water from any source that is processed to remove impurities. For example, distilled water and deionized water are the most common forms of purified water.

The supply pipe 220 is connected between the water supplying conduit 210 and the third spraying system 143 of the final rinsing device 140. In detail, the supply pipe 220 communicates with the third conveying pipe 144 of the third spraying system 143. In other words, the final rinsing device 140 may use purified water to rinse the substrate on the conveyor 180. In the illustrated embodiment as shown in FIG. 1, a first flow meter 201 is mounted on the supply pipe 220, to measure the amount of water that flows in the supply pipe 220 during a given period of time. Thus, the amount of water sprayed from the third upper and lower nozzles 146, 148 of the third spraying system 143 can be reflected from the first flow meter 201.

The connecting system 230 is connected between the third tank 141 of the final rinsing device 140 and the second spraying system 123 of the preliminary rinsing device 120. The connecting system 230 includes a first connecting pipe 231, a filter 332, a pump 233, a second connecting pipe 234, and a third connecting pipe 235. The first connecting pipe 231 is connected between the third tank 141 and the filter 232. The filter 232 and the pump 233 are connected in series. The second connecting pipe 234 is connected between the pump 233 and the third tank 141, thereby maintaining a predetermined amount of water in the third tank 141. The third connecting pipe 235 is connected between the pump 233 and the second spraying system 123. In detail, the third connecting pipe 235 communicates with the third conveying pipe 124 of the second spraying system 123. Thus, the water from the third tank 141 may be filtered and supplied to the second spraying system 123.

In the illustrated embodiment as in FIG. 1, a second flow meter 202 is mounted on the third connecting pipe 235, to measure the amount that flows in the third connecting pipe 235 during a given period of time. Thus, the amount of water sprayed from the second upper and lower nozzles 126, 128 of the second spraying system 123 can be reflected from the second flow meter 202.

The drain pipe 240 is connected between the second tank 121 and the drainage conduit 290, and configured for conveying water from the second tank 121 to the drainage conduit 290. In the illustrated embodiment, the drain pipe 240 is parallel to the supply pipe 220, the water supplying conduit 210 is parallel to the drainage conduit 290, and the drain pipe 240 is substantially perpendicular to the drainage conduit 290.

The water supplying system 200 works as follows. Purified water from the water supplying conduit 210 is supplied to the third spraying system 143 of the final rinsing device 140. In the final rinsing device 140, after the water spraying and rinsing the substrate on the conveyor 180, the water is defiled by the substrate and collected in the third tank 141. The defiled water is filtered and cleaned by the filter 232 and then supplied to the second spraying system 123 of the preliminary device 120. The filtered water is used to rinse the substrate on the conveyor 180 by the second spraying system 123 and then drained out through the second tank 121 and the first drain pipe 340.

When a substrate is conveyed by the conveyor 180 from the first acid cleaning device 110 to the final rinsing device 140 in sequence, the substrate may be processed in the following steps. The substrate is acid cleaned by the first spraying system 113, and then preliminarily rinsed, scrubbed, and finally rinsed, for example. In the final rinsing step, the water used to rinse the substrate is purified water; in the second step, the water used to rinse the substrate is filtered water from the final rinsing step. In other words, the purified water is reused and conserved in the water supply system 200.

In the illustrated embodiment as shown in FIG. 1, the final rinsing device 140 is capable of cleaning a substrate more effectively than the preliminary rinsing device 120, thus the final rinsing device 140 should be arranged succeeding the preliminary rinsing device 120. In other words, a conveying direction of the conveyor 180 should be from the preliminary rinsing device 120 to the final rinsing device 140.

It is noted that the acid cleaning device 110 and the scrubbing device 130 may be other suitable wet processing devices, such as devices for developing, etching, or stripping, in another embodiment. The conveyor 180 may be other suitable mechanisms, for example, a motor driven belt or other mechanically driven bulk material handling device.

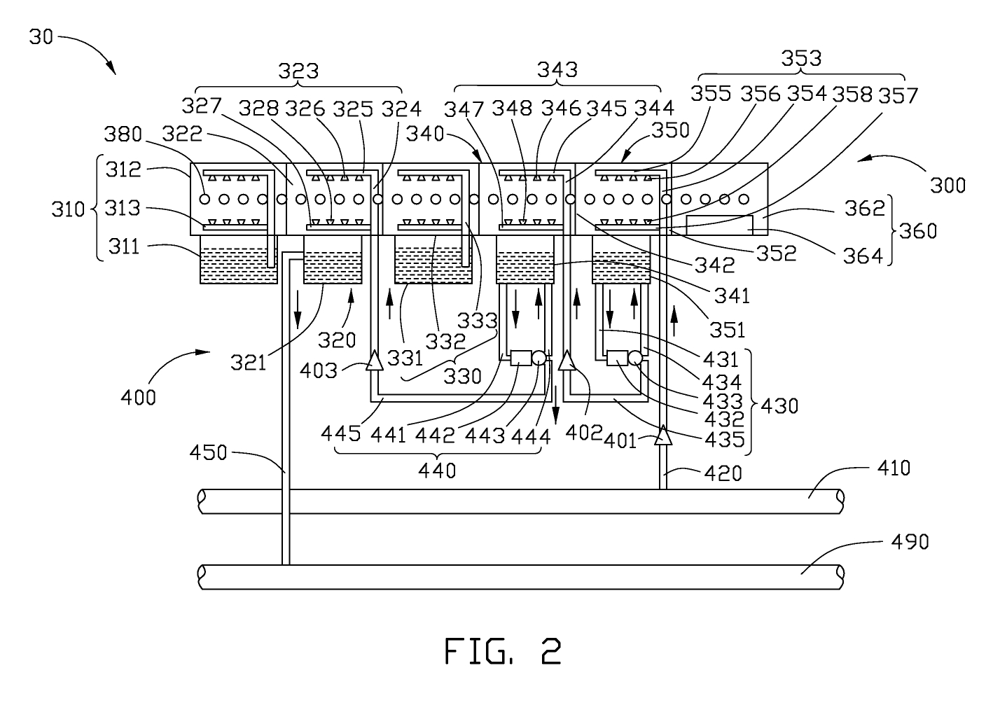

Referring to FIG. 2, an apparatus 30 for wet processing a substrate, in accordance with a second embodiment, is shown. The apparatus 30 comprises a wet processing system 300 and a water supplying system 400. The wet processing system 300 comprises a microetching device 310, a first preliminary rinsing device 320, an acid cleaning device 330, a second preliminary rinsing device 340, a final rinsing device 350, a drying device 360, and a conveyor 380 extending through the devices 310 through 360. The devices 310 through 360 are arranged close together along a line in sequence of processing steps of a substrate. In the illustrated embodiment, the processing steps are microetching, preliminary water rinsing, acid cleaning, preliminary water rinsing, final water rinsing, and drying, and the conveyor 380 is capable of conveying substrates from the step of microetching to the step of drying.

The microetching device 310 includes a first tank 311, a first housing 312, and a first spraying system 313. The first tank 311 is configured for receiving a wet processing liquid, which is capable of slightly etching a substrate. The first housing 312 and the first spraying system 313 each have similar structures and functions to the first housing 112 and the first spraying system 113 of the first embodiment, respectively.

The first preliminary rinsing device 320 has a structure and function similar to that of the preliminary rinsing device 120 of the first embodiment. The first preliminary rinsing device 320 includes a second tank 321 capable of receiving water, a second housing 322 above the second tank 321, and a second spraying system 323 accommodated in the second housing 322. The second spraying system 323 is used to spraying water to two opposite sides of the substrate on the conveyor 380, and includes a first conveying pipe 324, a first upper pipe 325 above the conveyor 380, a number of first upper nozzles 326 mounted on the first upper pipe 325, a first lower pipe 327 below the conveyor 380, and a number of first lower nozzles 328 mounted on the first lower pipe 327.

The acid cleaning device 330 includes a third tank 331 configured for receiving a proper etchant therein, a third housing 332 above the third tank 331, and a third spraying system 333 accommodated in the third housing 332. The third spraying system 333 has a structure suitable for spraying an etchant to two opposite sides of the substrate on the conveyor 380. In the illustrated embodiment as shown in FIG. 2, the third spraying system 333 has a structure similar to the first spraying system 313.

The second preliminary rinsing device 340 has structure and function similar to that of the first preliminary rinsing device 320. The second preliminary rinsing device 340 includes a fourth tank 341 for receiving water therein, a fourth housing 342 above the fourth tank 341, and a fourth spraying system 343 accommodated in the fourth housing 342. The fourth spraying system 343 includes a second conveying pipe 344, a second upper pipe 345 above the conveyor 380, a number of second upper nozzles 346 mounted on the second upper pipe 345, a second lower pipe 347 below the conveyor 380, and a number of second lower nozzles 348 mounted on the second lower pipe 347.

The final rinsing device 350 has a structure and function similar to that of the final rinsing device 140 of the first embodiment. The final rinsing device 350 includes a fifth tank 351 for receiving water therein, a fifth housing 352 above the fifth tank 351, and a fifth spraying system 353 accommodated in the fifth housing 352. The fifth spraying system 353 includes a third conveying pipe 354, a third upper pipe 355 above the conveyor 380, a number of third upper nozzles 356 mounted on the third upper pipe 355, a third lower pipe 357 below the conveyor 380, and a number of third lower nozzles 358 mounted on the third lower pipe 357.

The drying device 360 includes a sixth housing 362 and a drying element 364 arranged in the sixth housing 362. The drying element 364 is below the conveyor 380, and is configured for drying the substrate on the conveyor 380.

The water supplying system 400 is arranged below the wet processing system 300, and is configured for supplying purified water to the final rinsing device 350 and draining wastewater from the first preliminary rinsing device 320. The water supplying system 400 includes a water supplying conduit 410, a supply pipe 420, a first connecting system 430, a second connecting system 440, a drain pipe 450, and a drainage conduit 490.

The water supplying conduit 410 is substantially parallel with the line along which the devices 310 through 360 are arranged. The water supplying conduit 410 is configured for supplying purified water, such as distilled water or deionized water.

The supply pipe 420 is connected between the water supplying conduit 410 and the third spraying system 353 of the final rinsing device 350. In detail, the supply pipe 420 communicates with the third conveying pipe 354 of the fifth spraying system 353. In other words, the final rinsing device 350 may use purified water to rinse the substrate on the conveyor 380. In the illustrated embodiment as shown in FIG. 2, a first flow meter 401 is mounted on the supply pipe 420, to measure the amount that flows in the supply pipe 420 during a given period of time. Thus, the amount of water sprayed from the third upper and lower nozzles 356, 358 of the third spraying system 353 can be reflected from the first flow meter 401.

The first connecting system 430 is connected between the fifth tank 351 of the final rinsing device 350 and the second spraying system 343 of the second preliminary rinsing device 340. The first connecting system 430 includes a first connecting pipe 431, a first filter 432, a first pump 433, a second connecting pipe 434, and a third connecting pipe 435. The first connecting pipe 431 is connected between the fifth tank 351 and the first filter 432. The first filter 432 and the first pump 433 are connected in series. The second connecting pipe 434 is connected between the first pump 433 and the fifth tank 351, thereby maintaining a predetermined amount of water in the fifth tank 351. The third connecting pipe 435 is connected between the first pump 433 and the second spraying system 343. In detail, the third connecting pipe 435 communicates with the second conveying pipe 344 of the fourth spraying system 343. In the illustrated embodiment as shown in FIG. 2, a second flow meter 402 is mounted on the third connecting pipe 335, to measure the amount that flows during a given period of time. Thus, the amount of water sprayed from the second upper and lower nozzles 346, 348 of the second spraying system 343 can be reflected from the second flow meter 402.

The second connecting system 440 is connected between the fourth tank 341 of the second preliminary rinsing device 340 and the first spraying system 323 of the first preliminary rinsing device 380. The second connecting system 440 has a structure similar to that of the first connecting system 430. The second connecting system 440 includes a fourth connecting pipe 441, a second filter 442, a second pump 443, a fifth connecting pipe 444, and a sixth connecting pipe 445. The fourth connecting pipe 441 is connected between the fourth tank 341 and the second filter 442. The second filter 442 and the second pump 443 are connected in series. The fifth connecting pipe 444 is connected between the second pump 443 and the fourth tank 341, thereby maintaining a predetermined amount of water in the fourth tank 341. The sixth connecting pipe 445 is connected between the second pump 443 and the second spraying system 323. In detail, the sixth connecting pipe 445 communicates with the first conveying pipe 324 of the second spraying system 323. In the second embodiment as shown in FIG. 2, a third flow meter 403 is mounted on the sixth connecting pipe 445, to measure the amount that flows in the sixth connecting pipe 445 during a given period of time. Thus, the amount of water sprayed from the first upper and lower nozzles 326, 328 of the second spraying system 323 can be reflected from the third flow meter 403.

The drain pipe 450 is connected between the second tank 321 and the drainage conduit 490, and configured for conveying water from the second tank 321 to the drainage conduit 490. In the second embodiment, the drain pipe 450 is substantially parallel to the supply pipe 420, and is substantially perpendicular to the drainage conduit 490.

In the water supplying system 400, the final rinsing device 350 uses purified water to rinse the substrate on the conveyor 380, the second preliminary rinsing device 340 uses filtered water from the final rinsing device 350 to rinse the substrate, and the first preliminary rinsing device 320 uses filtered water from the second preliminary rinsing device 340 to rinse the substrate. In other words, the purified water is reused in the water supply system 400.

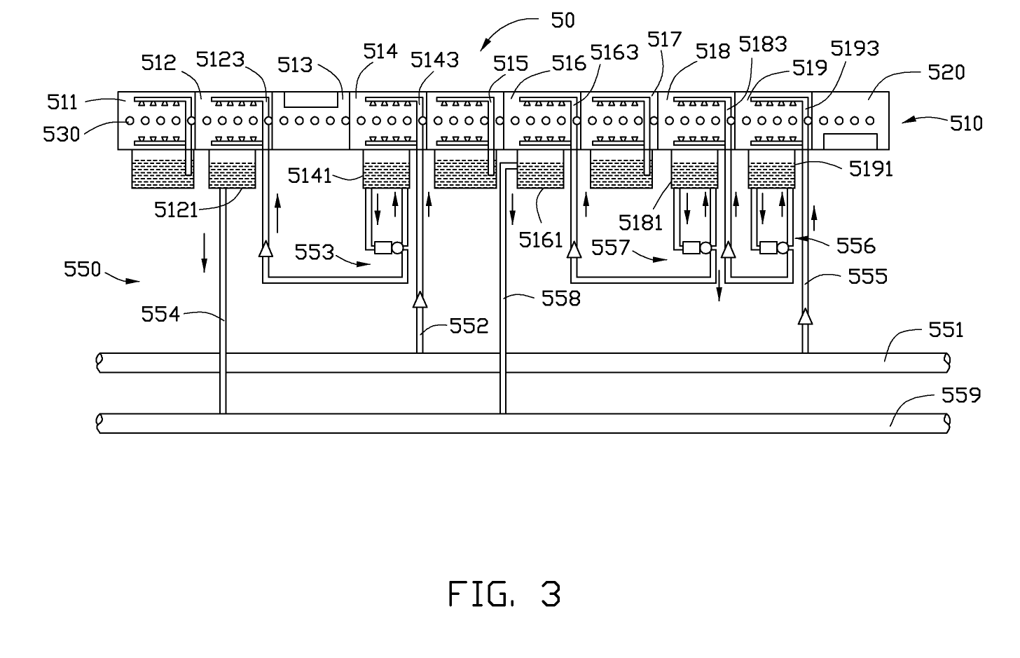

Referring to FIG. 3, an apparatus 50 for wet processing a substrate, in accordance with a third embodiment, is shown. The apparatus 50 is constituted by the apparatus 10 of the first embodiment and the apparatus 30 of the second embodiment.

In other words, the apparatus 50 includes a wet processing system 510 and a water supplying system 550. The wet processing system 510 comprises a first acid cleaning device 511, a first preliminary rinsing device 512, a scrubbing device 513, a first final rinsing device 514, a microetching device 515, a second preliminary rinsing device 516, a second acid cleaning device 517, a third preliminary rinsing device 518, a second final rinsing device 519, a drying device 520, and a conveyor 530 extending through the devices 511 through 520. The devices 511 through 520 are arranged close together along a line in sequence of processing steps of a substrate. In the illustrated embodiment of FIG. 3, the processing steps are acid cleaning, preliminary water rinsing, scrubbing, final water rinsing, microetching, preliminary water rinsing, acid cleaning, preliminary water rinsing, final water rinsing, and drying. The conveyor 530 is configured for conveying substrates thereon from the step of acid cleaning to the step of drying in sequence.

In particular, the first preliminary rinsing device 512 includes a first tank 5121 and a first spraying system 5123, the first final rinsing device 514 includes a second tank 5141 and a second spraying system 5143, the second preliminary rinsing device 516 includes a third tank 5161 and a third spraying system 5163, the third preliminary rinsing device 518 includes a fourth tank 5181 and a fourth spraying system 5183, and the second final rinsing device 519 includes a fifth spraying tank 5191 and a fifth spraying system 5193.

The water supplying system 550 is arranged below the wet processing system 510, and is configured for supplying water to the first and second final rinsing devices 514, 519 to rinse a substrate delivered by the conveyor 530. The water supplying system 550 includes a water supplying conduit 551, a first supply pipe 552, a first connecting system 553, a first drain pipe 554, a second supply pipe 555, a second connecting system 556, a third connecting system 557, a second drain pipe 558, and a drainage conduit 559.

The water supplying conduit 551 is substantially parallel with the line along which the devices 511 through 520 are arranged. The water supplying conduit 551 is configured for supplying purified water. The first supply pipe 552 is connected between the water supplying conduit 551 and the second spraying system 5143 of the first final rinsing device 514. In other words, the first final rinsing device 514 may use purified water to rinse the substrate on the conveyor 530. The first connecting system 553 is connected between the second tank 5141 of the first final rinsing device 514 and the first spraying system 5123 of the first preliminary rinsing device 512. The first connecting system 553 is capable of filtering and cleaning water flowed from the second tank 5141 and supplying the filtered water to the first spraying system 5123. The first drain pipe 554 is connected between the first tank 512 and the drainage conduit 559, and configured for conveying water from the first tank 512 to the drainage conduit 559.

The second supply pipe 555 is parallel to the first supply pipe 552, and is connected between the water supplying conduit 551 and the fifth spraying system 5193 of the second final rinsing device 519. The second connecting system 556 is connected between the fifth tank 5191 of the second final rinsing device 519 and the fourth spraying system 5183 of the third preliminary rinsing device 518. The second connecting system 556 is capable of filtering and cleaning water flowed from the fifth tank 5191 and supplying the filtered water to the fourth spraying system 5183. The third connecting system 557 is connected between the fourth tank 5181 of the third preliminary rinsing device 518 and the third spraying system 5163 of the second preliminary rinsing device 516. The third connecting system 557 is capable of filtering and cleaning water flowed from the fourth tank 5181 and supplying the filtered water to the third spraying system 5163. The second drain pipe 558 is connected between the third tank 5161 and the drainage conduit 559.

In the apparatus 50 of the third embodiment, the purified water is also reused and conserved.

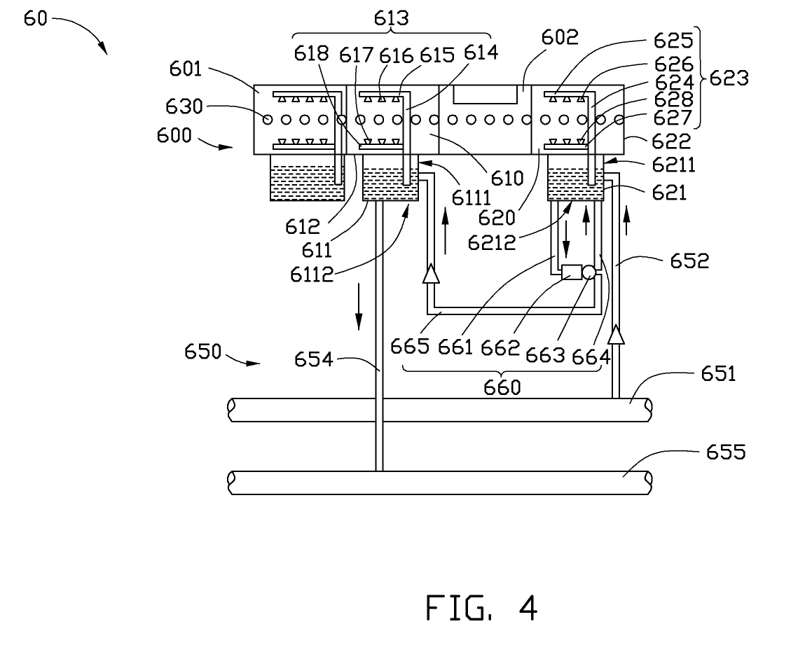

FIG. 4 illustrates an apparatus 60 for wet processing a substrate in accordance with a fourth embodiment. The apparatus 60 has a structure similar to the apparatus 10 of the first embodiment. The apparatus 60 comprises a wet processing system 600 and a water supplying system 650.

The wet processing system 600 comprises an acid cleaning device 601, a preliminary rinsing device 610, a scrubbing device 602, a final rinsing device 620, and a conveyor 630. In particular, the preliminary rinsing device 610 includes a first tank 611, a first housing 612 above the first tank 611, and a first spraying system 613 accommodated in the first housing 612. The first tank 611 is configured for receiving/collecting water therein, and has a side wall 6111 and a bottom wall 6112. The first spraying system 613 includes a first conveying pipe 614, a first upper pipe 615 above the conveyor 630, a number of first upper nozzles 616 mounted on the first upper pipe 615, a first lower pipe 617 below the conveyor 630, and a number of first lower nozzles 618 mounted on the first lower pipe 617. One end of the first conveying pipe 614 is immersed in the water of the first tank 611, and the other end is connected with the first upper pipe 615.

The final rinsing device 620 includes a second tank 621, a second housing 622 above the second tank 621, and a second spraying system 623 accommodated in the second housing 622. The second tank 621 is configured for receiving/collecting water therein, and has a side wall 6111 and a bottom wall 6212. The second spraying system 623 includes a second conveying pipe 624, a second upper pipe 625 above the conveyor 630, a number of second upper nozzles 626 mounted on the second upper pipe 625, a second lower pipe 627 below the conveyor 630, and a number of second lower nozzles 628 mounted on the second lower pipe 627. One end of the second conveying pipe 624 is immersed in the water of the second tank 621, the other end of the second conveying pipe 624 is connected with the second upper pipe 625.

The water supplying system 650 is arranged below the wet processing system 600, and is configured for supplying water to the final rinsing device 620 and draining wastewater from the preliminary rinsing device 610. The water supplying system 650 includes a water supplying conduit 651, a supply pipe 652, a connecting system 660, a drain pipe 654, and a drainage conduit 655. The water supplying conduit 651 is configured for supplying purified water. The water supply pipe 652 is mounted on the side wall 6211 of the second tank 621, and communicates with the second tank 621 and the water supplying conduit 651.

The connecting system 660 includes a first connecting pipe 661, a filter 662, a pump 663, a second connecting pipe 664, and a third connecting pipe 665. The first connecting pipe 661 is mounted on the bottom wall 6212 of the second tank 621, and communicates the second tank 621 and the filter 662. The filter 662 and the pump 663 are connected in series. The second connecting pipe 664 is also mounted on the bottom wall 6212 of the second tank 621, and communicates the pump 663 and the second tank 621. The third connecting pipe 665 is mounted on the side wall 6111 of the first tank 611, and communicates the first tank 611 and the pump 663.

The drain pipe 654 is mounted on the bottom wall 6112 of the first tank 611, and configured for conveying water from the first tank 611 to the drainage conduit 655. The drainage conduit 655 is configured of drainage of wastewater.

In the illustrated embodiment of FIG. 4, the apparatus 60 works as follows. A substrate may be placed on the conveyor 630 to be conveyed from the acid cleaning device 601 to the final rinsing device 620, and would be sequentially processed in steps of acid cleaning, preliminary rinsing, scrubbing, and final rinsing. In the step of final rinsing, the substrate is rinsed by water from the second tank 621. The water in the second tank 621 is substantially constituted by purified water from the water supplying conduit 651. In the step of preliminary rinsing, the substrate is rinsed by water from the first tank 611. The water in the first tank 611 is substantially constituted by water supplied from the second tank 621 and filtered by the filter 662. That is, the purified water is reused and conserved in the apparatus 60.

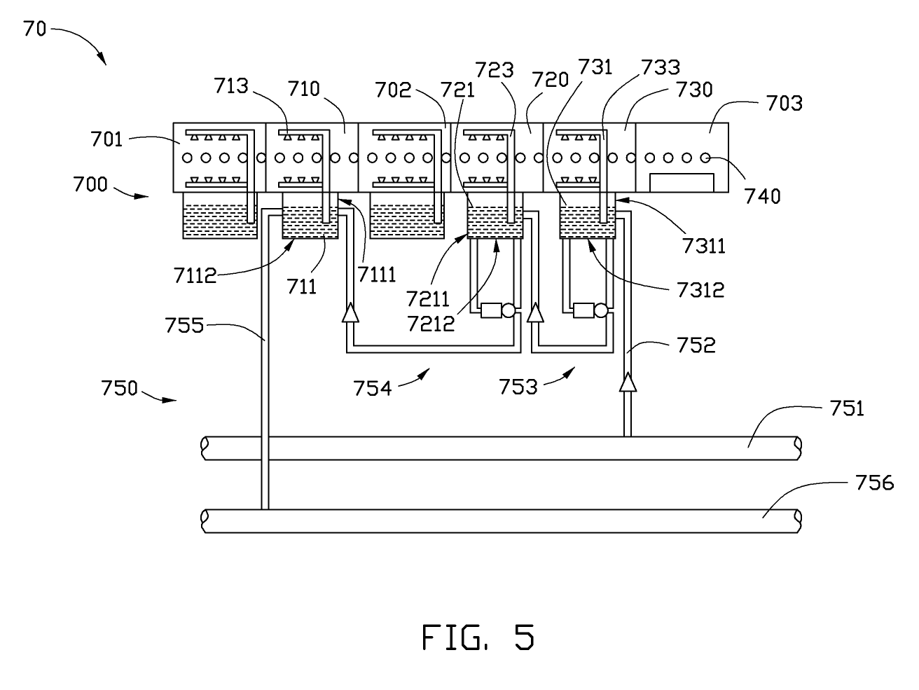

FIG. 5 illustrates an apparatus 70 for wet processing a substrate in accordance with a fifth embodiment. The apparatus 70 has a structure similar to that of the apparatus 30 of the second embodiment. The apparatus 70 comprises a wet processing system 700 and a water supplying system 750.

The wet processing system 700 comprises a microetching device 701, a first preliminary rinsing device 710, an acid cleaning device 702, a second preliminary rinsing device 720, a final rinsing device 730, a drying device 703, and a conveyor 740. The microetching device 701, the first preliminary rinsing device 710, the acid cleaning device 702, the second preliminary rinsing device 720, the final rinsing device 730, the drying device 703, and the conveyor 740 have structures similar to that of the microetching device 310, the first preliminary device 320, the acid cleaning device 330, the second preliminary rinsing device 340, the final rinsing device 350, the drying device 360, and the conveyor 380 of the second embodiment, respectively.

In particular, the first preliminary rinsing device 710 includes a first tank 711 and a first spraying system 713. The first tank 711 has a side wall 7111 and a bottom wall 7112. A portion of the first spraying system 713 is immersed in the water of the first tank 711, thus that the first spraying system 713 may divert water in the first tank 711 and spray the water to two opposite sides of the substrate on the convey 740. The second preliminary rinsing device 720 includes a second tank 721 and a second spraying system 723. The second tank 721 has a side wall 7211 and a bottom wall 7212. A portion of the second spraying system 723 is immersed in the water of the second tank 721 for diverting water therein. The final rinsing device 730 includes a third tank 731 and a third spraying system 733. The third tank 731 has a side wall 7311 and a bottom wall 7312. A portion of the third spraying system 733 is immersed in the water of the third tank 731 for diverting water therein.

The water supplying system 750 is arranged below the wet processing system 700, and is configured for supplying water to the final rinsing device 730. The water supplying system 750 includes a water supplying conduit 751, a supply pipe 752, a first connecting system 753, a second connecting system 754, a drain pipe 755, and a drainage conduit 756. The water supplying conduit 751 is configured for supplying purified water. The water supply pipe 752 is mounted on the side wall 7311 of the third tank 731, and communicates with the third tank 731 and the water supplying conduit 751. The first connecting system 753 communicates the third tank 731 and the second tank 721. In detail, the first connecting system 753 is mounted at the bottom wall 7312 of the third tank 731 and the side wall 7211 of the second tank 721. The second connecting system 754 communicates the second tank 721 and the first tank 711. In detail, the second connecting system 754 is mounted at the bottom wall 7212 of the second tank 721 and the side wall 7111 of the first tank 711. The drain pipe 755 is mounted on the side wall 7111 of the first tank 711, and is configured for conveying water from the first tank 711 to the drainage conduit 756. The drainage conduit 756 is configured of drainage of wastewater. In the illustrated embodiment as shown in FIG. 5, distilled water or deionized water applied by the water supplying conduit 751 is reused in the wet processing system 700.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

1. An apparatus for wet processing a substrate, the apparatus comprising:
a wet processing system comprising:
a preliminary rinsing device comprising a first tank and a first spraying system above the first tank, the first tank being configured for collecting water sprayed by the first spraying system;
a final rinsing device comprising a second tank and a second spraying system above the second tank, the second tank being configured for collecting water sprayed by the second spraying system; and
a conveyor extending along an arrangement of the preliminary rinsing device and the final rinsing device, the conveyor being configured for conveying a substrate from the preliminary rinsing device to the final rinsing device thereby preliminarily rinsing the substrate using the preliminary rinsing device and then finally rinsing the substrate using the final rinsing device; and
a water supplying system, comprising:
a supply pipe configured for supplying water to the second spraying system;
a connecting system communicating with the second tank and the first spraying system, the connecting system being configured for supplying water from the second tank to the first spraying system; and
a drain pipe communicating with the first tank, the drain pipe being configured for draining out the water in the first tank.

2. The apparatus of claim 1, wherein the connecting system comprises a first connecting pipe, a filter, a pump, and a second connecting pipe, the first connecting pipe communicates with the second tank and the filter, the filter and the pump are connected in series, the second connecting pipe communicates with the pump and the first spraying system.

3. The apparatus of claim 2, wherein a first flow meter is mounted on the supply pipe, and a second flow meter is mounted on the second connecting pipe.

4. The apparatus of claim 2, wherein the first spraying system comprises a first conveying pipe communicating with the second connecting pipe, a first upper pipe above the conveyor, and a number of first upper nozzles mounted on the first upper pipe, the second spraying system comprises a second conveying pipe communicating with the supply pipe, a second upper pipe above the conveyor, and a number of second upper nozzles mounted on the second upper pipe, the first and second upper nozzles opposite to the conveyor.

5. The apparatus of claim 1, wherein the water supplying system further comprises a water supplying conduit and a drainage conduit, the supply pipe connected between the water supplying conduit and the second spraying system, the drain pipe connected between the first tank and the drainage conduit.

6. The apparatus of claim 5, wherein the supply pipe is parallel to the drain pipe, the water supplying conduit is parallel to the drainage conduit, and the supply pipe is perpendicular to the water supplying conduit.

7. The apparatus of claim 1, wherein the wet processing system further comprises an acid cleaning device preceding the preliminary device and a scrubbing device arranged between the preliminary rinsing device and the final rinsing device, the acid cleaning device, the preliminary rinsing device, the scrubbing device, and the final rinsing device are arranged along a line in order written, the conveyor extends along the arrangement of the acid cleaning device, the preliminary rinsing device, the scrubbing device, and the final rinsing device, and is configured for conveying substrate from the acid cleaning device to the final rinsing device.

8. An apparatus for wet processing a substrate, the apparatus comprising:
a wet processing system comprising:
a first preliminary rinsing device comprising a first tank and a first spraying system above the first tank, the first tank being configured for collecting water sprayed by the first spraying system;
a second preliminary rinsing device comprising a second tank and a second spraying system above the second tank, the second tank being configured for collecting water sprayed by the second spraying system;
a final rinsing device including a third tank and a third spraying system above the third tank, the third tank being configured for collecting water sprayed by the third spraying system; and
a conveyor extending along an arrangement of the first preliminary rinsing device, the second preliminary rinsing device, and the final rinsing device, the conveyor configured for conveying a substrate from the first preliminary rinsing device to the final rinsing device thereby preliminarily rinsing the substrate using the first preliminary rinsing device and then finally rinsing the substrate using the final rinsing device; and
a water supplying system, comprising:
a supply pipe configured for supplying water to the third spraying system;
a first connecting system communicating with the third tank and the second spraying system, the first connecting system being configured for supplying water from the third tank to the second spraying system;
a second connecting system communicating with the second tank and the first spraying system, the second connecting system being configured for supplying water from the second tank to the first spraying system; and
a drain pipe communicating with the first tank, the drain pipe being configured for draining out water in the first tank.

9. The apparatus of claim 8, wherein the first connecting system comprises a first connecting pipe, a first filter, a first pump, and a second connecting pipe, the first connecting pipe communicates with the third tank and the first filter, the first filter and the first pump are connected in series, the second connecting pipe communicates with the first pump and the second spraying system, the second connecting system comprises a third connecting pipe, a second filter, a second pump, and a fourth connecting pipe, the third connecting pipe communicates with the second tank and the second filter, the second filter and the second pump are connected in series, the fourth connecting pipe communicates with the second pump and the first spraying system.

10. The apparatus of claim 9, wherein a first flow meter is mounted on the supply pipe, a second flow meter is mounted on the second connecting pipe, and a third flow meter is mounted on the fourth connecting pipe.

11. The apparatus of claim 9, wherein the first spraying system comprises a first conveying pipe communicating with the fourth connecting pipe, a first upper pipe above the conveyor, and a number of first upper nozzles mounted on the first upper pipe, the second spraying system comprises a second conveying pipe communicating with the second connecting pipe, a second upper pipe above the conveyor, and a number of second upper nozzles mounted on the second upper pipe, the third spraying system comprises a third conveying pipe communicating with the supply pipe, a third upper pipe above the conveyor, and a number of third upper nozzles mounted on the third upper pipe.

12. The apparatus of claim 8, wherein the water supplying system further comprises a water supplying conduit and a drainage conduit, the supply pipe connected between the water supplying conduit and the second spraying system, the drain pipe connected between the first tank and the drainage conduit, the water supplying conduit is parallel to the drainage conduit, and the supply pipe is perpendicular to the water supplying conduit.

13. The apparatus of claim 8, wherein the wet processing system further comprises a microetching device preceding the first preliminary device, an acid cleaning device arranged between the first preliminary rinsing device and the second preliminary rinsing device, and a drying device succeeding the final rinsing device, the microetching device, the first preliminary rinsing device, the acid cleaning device, the second preliminary rinsing device, the final rinsing device, and the drying device are arranged along a line in order written, the conveyor extends along an arrangement of the microetching device, the first preliminary rinsing device, the acid cleaning device, the second preliminary rinsing device, the final rinsing device, and the drying device, and the conveyor is configured for conveying substrate from the microetching device to the drying device.

14. An apparatus for wet processing a substrate, the apparatus comprising:
a wet processing system comprising:
a preliminary rinsing device comprising a first tank and a first spraying system, the first tank being configured for receiving water therein, the first spraying system comprising a first conveying pipe, a first upper pipe communicating with the first conveying pipe, and a number of first upper nozzles mounted on the first upper pipe, one end of the first conveying pipe being immersed in the water of the first tank;
a final rinsing device comprising a second tank and a second spraying system, the second tank being configured for receiving water therein, the second spraying system comprising a second conveying pipe, a second upper pipe communicating with the second conveying pipe, and a number of first upper nozzles mounted on the first upper pipe, one end of the second conveying pipe being immersed in the water of the second tank; and
a conveyor extending along an arrangement of the preliminary rinsing device and the final rinsing device, the conveyor being configured for conveying a substrate from the preliminary rinsing device to the final rinsing device thereby preliminarily rinsing the substrate using the preliminary rinsing device and then finally rinsing the substrate using the final rinsing device, the first and second upper nozzles being opposite to the conveyor; and
a water supplying system, comprising:
a supply pipe configured for supplying water to the second tank;
a connecting system communicating with the second tank and the first tank; the connecting system being configured for supplying water from the second tank to the first spraying system; and
a drain pipe communicating with the first tank, the drain pipe being configured for draining out the water in the first tank.

15. The apparatus of claim 14, wherein the connecting system comprises a first connecting pipe, a filter, a pump, and a second connecting pipe, the first connecting pipe communicates with the second tank and the filter, the filter and the pump are connected in series, the second connecting pipe communicates with the pump and the first tank.

16. The apparatus of claim 15, wherein a first flow meter is mounted on the supply pipe, and a second flow meter is mounted on the second connecting pipe.

17. The apparatus of claim 15, wherein the first tank includes a first bottom wall away from the first spraying system, the second connecting pipe is mounted on the first bottom wall, the second tank includes a second side wall and a second bottom wall away from the second spraying system, the supply pipe is mounted on the second side wall, the first connecting pipe is mounted on the second bottom wall.

18. The apparatus of claim 14, wherein the wet processing system further comprises an acid cleaning device preceding the preliminary device and a scrubbing device arranged between the preliminary rinsing device and the final rinsing device, the acid cleaning device, the preliminary rinsing device, the scrubbing device, and the final rinsing device are arranged along a line in order written, the conveyor extends along an arrangement of the acid cleaning device, the preliminary rinsing device, the scrubbing device, and the final rinsing device, and is configured for conveying substrate from the acid cleaning device to the final rinsing device.
